(19) United States
(12) Patent Application Publication
(10) Pub. No.: US 2026/0004453 A1
(43) Pub. Date: Jan. 1, 2026

(54) SAFETY RATED POSE ESTIMATION

(71) Applicant: THE BOEING COMPANY, Arlington, VA (US)

(72) Inventor: Beau T. COLLEY-ALLERTON, Melbourne (AU)

(21) Appl. No.: 18/755,530

(22) Filed: Jun. 26, 2024

(51) Int. Cl. G06T 7/73

(52) U.S. Cl. CPC G06T 7/74; G06T 2207/30196

(57) ABSTRACT

The present disclosure provides techniques and systems for safety-rated pose estimation. A first image depicting a subject from a first angle is received. A second image depicting the subject from a second angle is received. A first pose is generated by analyzing the first image, where the first pose comprises a first plurality of points, and each of the first plurality of points represents a part of the subject. A second pose is generated by analyzing the second image, where the second pose comprises a second plurality of points, and each of the second plurality of points represents a corresponding part of the subject as in the first pose. Each of the first plurality of points is compared with a corresponding point, of the second plurality of points, to determine a discrepancy. Upon determining that the discrepancy does not exceed a defined threshold, the first and second poses are aggregated to form a first master pose.

### FIELD

Aspects of the present disclosure relate to pose estimation, and, more specifically, to generating pose estimations for a safety-rated system with improved accuracy using multi-angle captured data.

### BACKGROUND

Current safety-rated systems primarily focus on basic presence detection, where the systems monitor the physical separation between a human and a potential hazard, such as machinery or robots. These traditional safety mechanisms require large safety zones, and therefore demand considerable space within industrial settings to effectively separate humans from hazards. This approach not only increases the factory footprint but also limits the potential for collaborative work between humans and machines, such as joint tasks where both agents interact closely.

### SUMMARY

The present disclosure provides a method in one aspect, including receiving a first image depicting a subject from a first angle, receiving a second image depicting the subject from a second angle, generating a first pose by analyzing the first image, where the first pose comprises a first plurality of points, and each of the first plurality of points represents a part of the subject, generating a second pose by analyzing the second image, where the second pose comprises a second plurality of points, and each of the second plurality of points represents a corresponding part of the subject as in the first pose, comparing each of the first plurality of points with a corresponding point, of the second plurality of points, to determine a discrepancy, and upon determining that the discrepancy does not exceed a defined threshold, aggregating the first and second poses to form a first master pose.

Other aspects of this disclosure provide one or more non-transitory computer-readable media containing, in any combination, computer program code that, when executed by the operation of a computer system, performs operations in accordance with one or more of the above methods, as well as systems comprising one or more computer processors and one or more memories containing one or more programs that, when executed by the one or more computer processors, perform operations in accordance with one or more of the above methods.

### BRIEF DESCRIPTION OF THE DRAWINGS

So that the manner in which the above recited features can be understood in detail, a more particular description, briefly summarized above, may be had by reference to example aspects, some of which are illustrated in the appended drawings.

FIGS. 1A and 1B depict an example workflow for enhanced pose estimation for a human operator using multi-angle image capture, according to some aspects of the present disclosure.

FIG. 2 depicts an example link frame pose and an example index table of human body parts for pose estimation, according to some aspects of the present disclosure.

FIG. 3 depicts an example coordinate table of human body parts across multiple preliminary poses, according to some aspects of the present disclosure.

FIGS. 4A and 4B depict an example workflow for enhanced pose estimation for a robot arm using multi-angle image capture, according to some aspects of the present disclosure.

FIG. 5 depicts an example workflow for generating control signals based on the validity of both an operator master pose and a robot master pose, according to some aspects of the present disclosure.

FIG. 6 depicts an example method for generating master poses and controlling robot operations based on the validity of the master poses, according to some aspects of the present disclosure.

FIG. 7 is a flow diagram depicting an example method for master pose estimation, according to some aspects of the present disclosure.

FIG. 8 depicts an example computing device supporting pose-based machine control and management, according to some aspects of the present disclosure.

### DETAILED DESCRIPTION

The present disclosure introduces mechanisms for enhanced pose estimation. Specifically, aspects of the present disclosure introduce a safety-rated system capable of determining the poses of human operators and machines using multi-angle captured data.

The current safety-rated system is limited to presence detection, which typically uses separation zones for monitoring interaction between humans and machines. For example, the systems often construct a two-dimensional (2D) plane of the working area, which, in combination with large physical barriers, helps to define safety zones around machinery or areas with potential hazards. These safety zones are used to limit human access to potentially dangerous interactions. When a person enters one of these predefined safety zones, the system automatically triggers an alert or sends a control signal that stops or shuts down the machine to prevent accidents.

However, the traditional safety-rated system, which primarily relies on binary indicators of presence, lacks the capability to interpret detailed human postures or the specific nature of human activities, such as whether the operators are bending over or reaching out, or whether their hands are positioned in a specific manner. This limitation restricts the system’s effectiveness in contexts where humans and robots collaborate closely, such as in advanced manufacturing or in environments using collaborative robots. Additionally, the establishment of safety zones by the traditional safety-rated system often requires a process, equipment, and location that permit enough space to effectively separate humans from hazards. This spatial requirement further limits the implementation of the system, particularly in environments where working space is constrained.

The present disclosure introduces techniques for tracking human poses and machine actions with improved accuracy and reliability. By integrating image data captured from multiple angles with link frame (or skeleton) pose estimation algorithms, the disclosed safety-rated system can not only detect a person’s presence in safety zones but also precisely interpret their poses, movements, and interactions with machinery in real time. Capturing the pose of a human can typically be conducted with 2D or three-dimensional (3D) cameras using various algorithms. However, the reliability of a single camera’s detection is often not sufficient for safety (or even non-safety) monitoring systems due to potential blind spots and/or limitations in depth perception. The present disclosure addresses these limitations by cross-checking several estimations from independent cameras (or sensors) to produce a master pose for tracking a human’s posture and movement while working in close proximity to machines within a defined operating area. The disclosed method may significantly improve the accuracy and reliability of link frame (or skeleton) pose estimation, to ensure that the safety-rated system can effectively monitor and respond to dynamic interactions between humans and machines.

In some aspects, the disclosed safety-rated system may first collect images that capture the human operator and/or the machine (e.g., robot arm) within the operating area from multiple cameras (or sensors). Each image may provide a different angle of view of the subject (e.g., the human operator and/or machine). These images may then be processed to generate preliminary poses for the human operator and the machine, respectively. Each set of the preliminary poses may be subject to a cross-verification process, where the system compares these preliminary poses to detect discrepancies between any two of the multiple estimations. If the discrepancies for either the human operator or the machine are equal to or fall below a defined threshold, the system may aggregate these preliminary poses to generate a corresponding master pose for the human operator or the machine. If, however, the discrepancies exceed the threshold, indicating potential errors in pose capture or estimation, the system may generate an error alert. In some aspects, the error alert may prompt further investigation and/or initiate immediate corrective actions or safety measures. After the master poses for both the human operator and the machine are confirmed valid (based on the cross-verification of discrepancies), the system may use these poses to generate control signals for the machine’s dynamic motion planning. In some aspects, these control signals may facilitate the execution of collaborative actions between the human operator and the machine in close proximity. If either the human operator’s or the machine’s master pose is found invalid, the system may generate an emergency stop (e-stop) signal to immediately stop or slow down the machine to prevent any potential injury or accident.

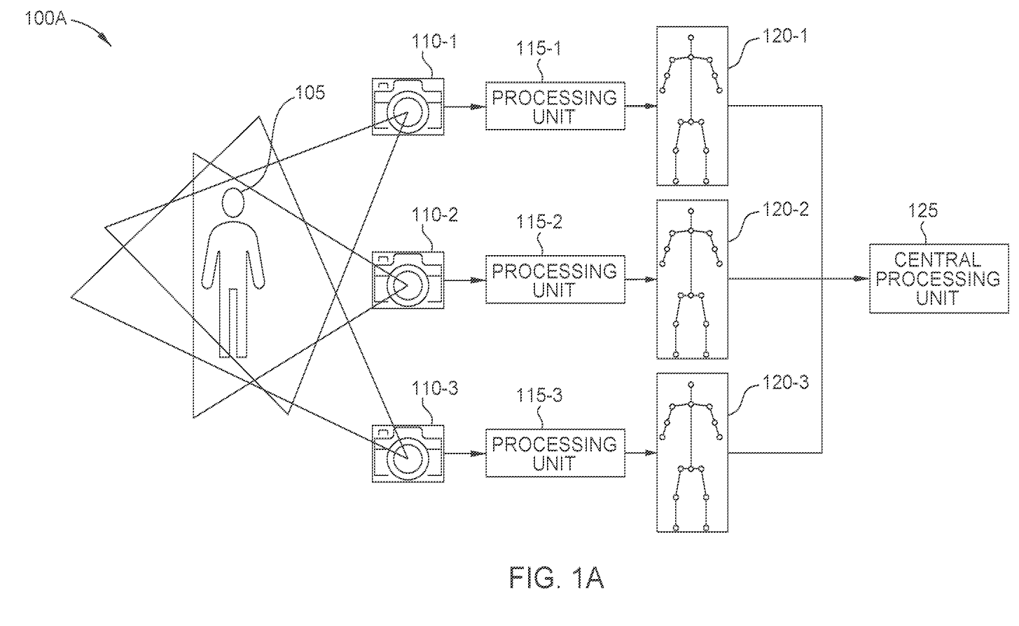

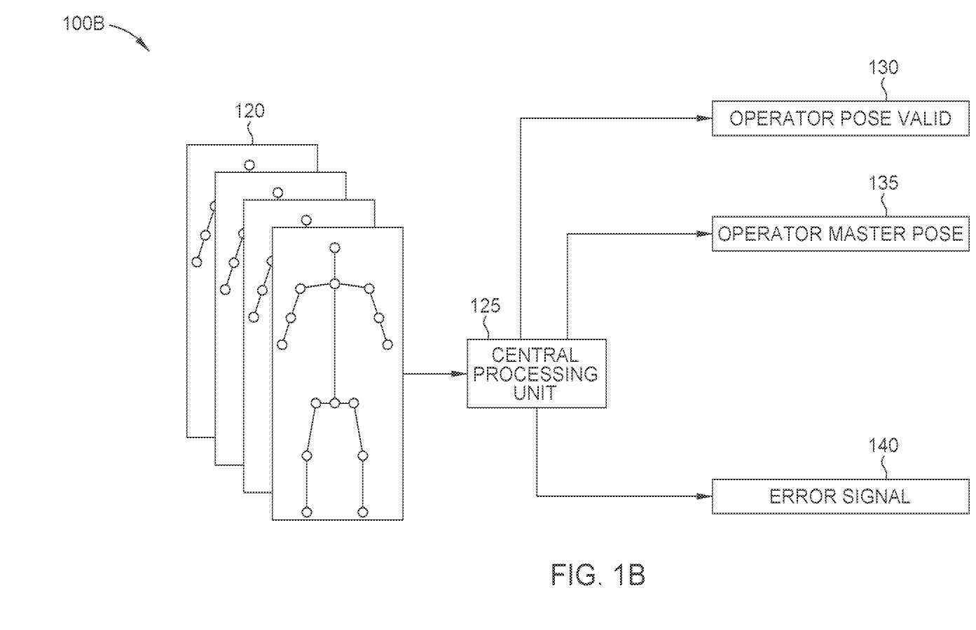

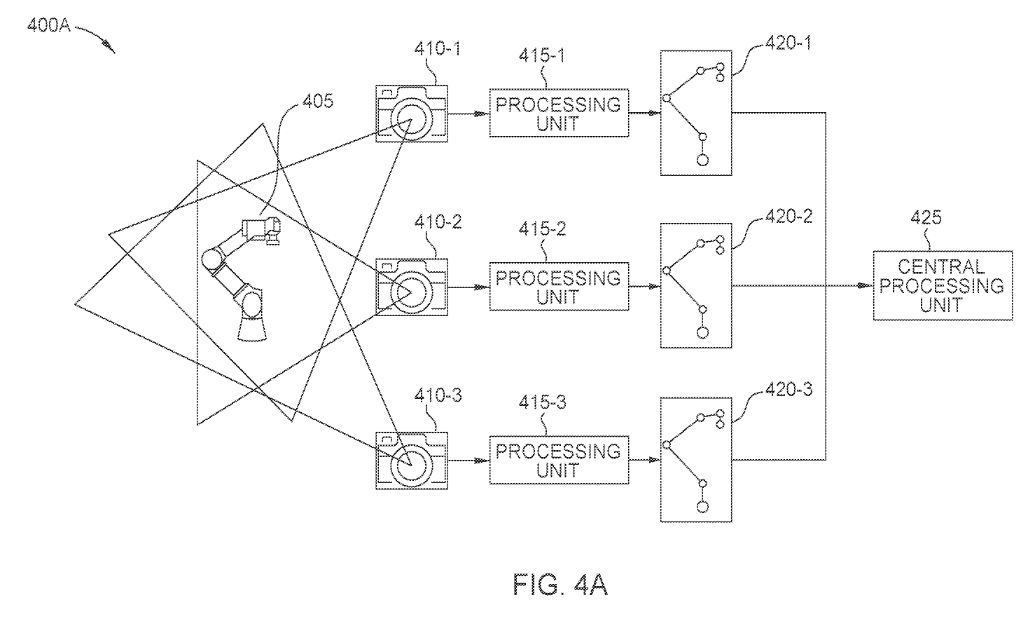

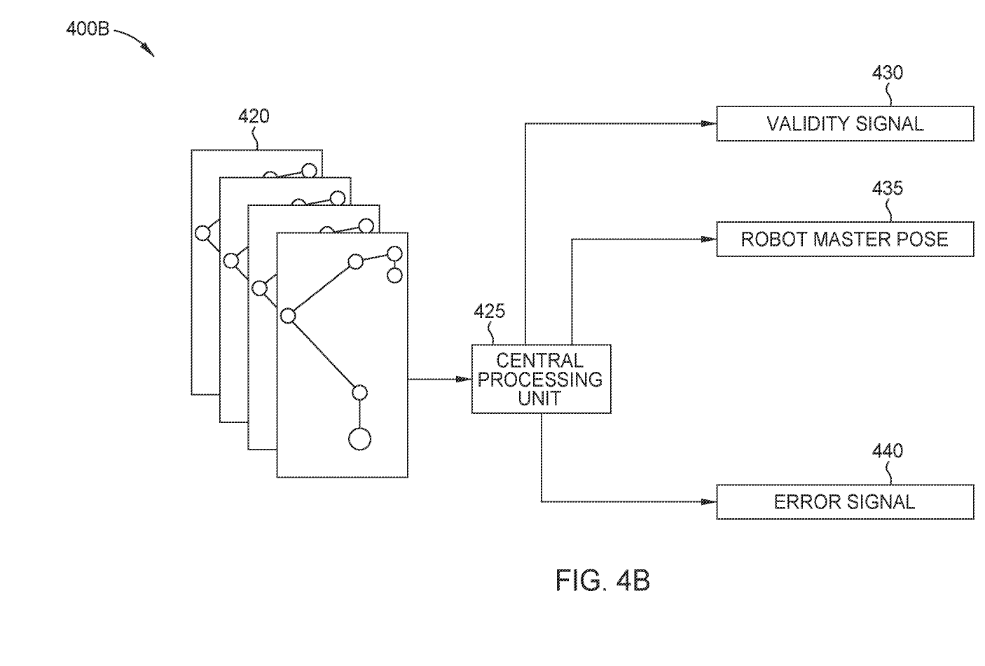

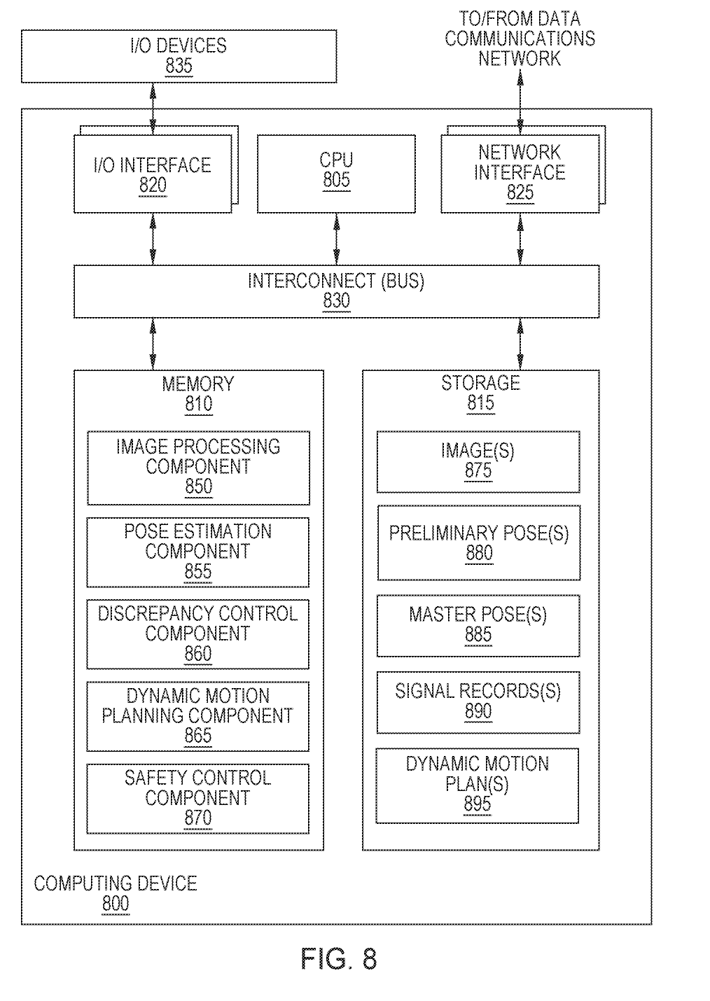

FIGS. 1A and 1B depict an example workflow for enhanced pose estimation for a human operator 105 using multi-angle image capture, according to some aspects of the present disclosure. In some aspects, the workflow 100A of FIG. 1A and workflow 100B of FIG. 1B (collectively, forming a workflow 100) may be performed by one or more computing devices, such as the built-in processing unit 115 or the central processing unit (CPU) 125 as illustrated in FIGS. 1A and 1B, the built-in processing unit 415 or the CPU 425 as illustrated in FIGS. 4A and 4B, and/or the computing device 800 as illustrated in FIG. 8.

In the illustrated workflow 100A, three cameras 110-1, 110-2, and 110-3 are used to capture the human operator’s 105 posture within a defined operating area. As illustrated, each camera 110 includes a built-in processing unit 115. These cameras may be mounted around the operating area to capture different angles of the human operator 105 at work. For example, in some aspects, the camera 110-1 may be positioned at the top-left corner, the camera 110-2 may be positioned at the top-right corner, and the camera 110-3 may be positioned at the bottom-left corner. Each camera 110 captures image data independently, and processes the data through its built-in processing unit 115 to generate a corresponding link frame (or skeleton) pose 120 for the human operator 105. For example, the camera 110-1 captures the human operator’s posture from the top-left corner and processes the data to generate a link frame pose 120-1. Similarly, the camera 110-2, positioned at the top-right corner, captures and processes data to generate a link frame pose 120-2, and the camera 110-3, positioned at the bottom-left corner, captures and processes data to generate a link frame pose 120-3. Each generated pose 120 provides a unique perspective on the human operator’s 105 positions and/or movements within the operating area. In some aspects, the generated poses 120 may be referred to as preliminary poses because they serve as initial estimations that will be cross-verified and refined to generate a master pose. As illustrated, each individual preliminary pose 120 are then be transmitted to the CPU 125 for cross-verification.

In some aspects, the link frame (or skeleton) pose representing the human operator’s 105 posture may involve using different points to mark important parts or joints of the human body, such as the nose, neck, right shoulder, left shoulder, right elbow, left elbow, and the like. These points may then be connected together to form a skeletal structure that maps out the dynamic posture of the human operator 105.

In the illustrated workflow 100B of FIG. 1B, each of the preliminary poses 120 is then processed by the CPU 125, which compares these poses to determine whether there is a discrepancy between any two poses exceeding a defined threshold. In some aspects, the discrepancy may be measured by comparing the distance between the same points across different poses. For example, each point in the link frame (or skeleton) pose 120 may have a set of coordinates (x, y, z). When the CPU 125 determines that the coordinates of a point in the first pose are different from those of a corresponding point in the second pose, it may calculate the distance between these points and compare it with a threshold. If the distance exceeds the threshold, it may indicate a potential error or anomaly in the pose capture or estimation process. In this configuration, the CPU 125 may generate an error signal 140, and send it to a safety control system, which automatically pauses, slows down, or stops the machine that the human operator 105 is actively working with. If the error signal 140 persists for a period of time, certain corrective actions may be conducted by the system operators, including, but not limited to, recalibrating the cameras 110, reanalyzing the captured data, or adjusting the corresponding pose estimation algorithms.

If the distance is equal to or falls below the threshold, suggesting the discrepancy is within an acceptable limit, the CPU 125 may determine that the pose is accurate. Once the cross-verification process is complete that all preliminary poses 120 are confirmed to align within the threshold, the CPU may aggregate these validated preliminary poses into a master pose 135 for the human operator 105. In some aspects, the master pose 135 may be more reliable than individual poses 120 generated by a single camera in that it integrates data from various camera angles, therefore reducing the impact of any one camera’s potential distortions or blind spots. As illustrated, following the determination that all individual poses are aligned and the generation of the master pose, a signal 130 is generated to indicate that the master pose 135 is valid and can be used for further action.

In some aspects, the master pose 135 for the human operator 105 may be generated continuously to track the operator’s movements in real time and guide human-machine interactions.

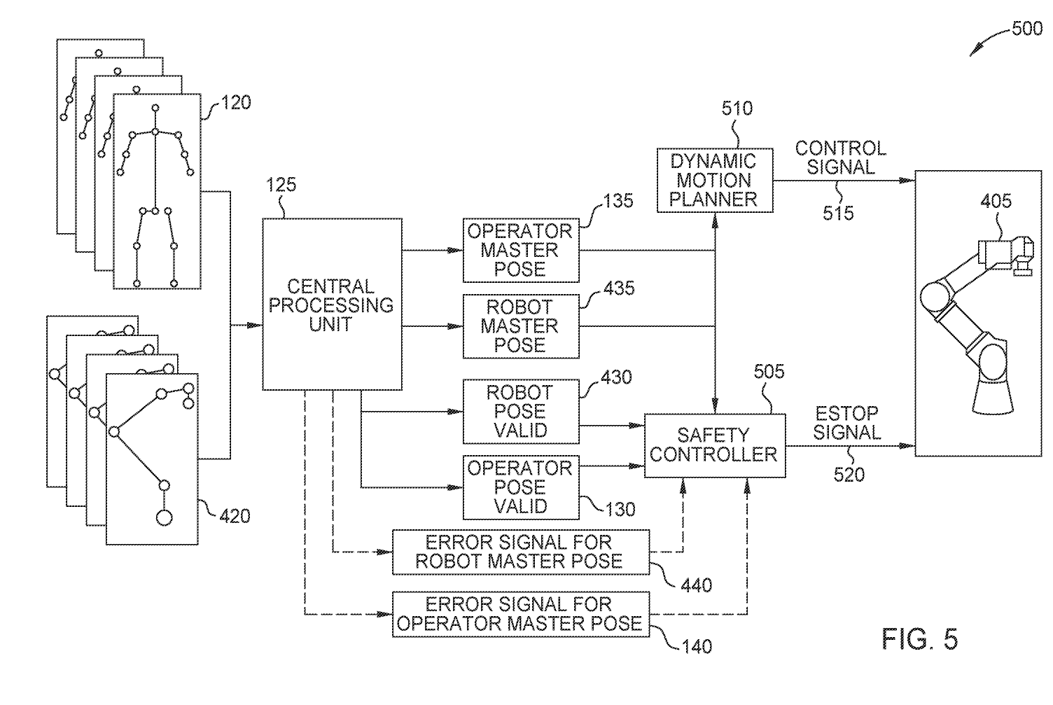

In some aspects, if the CPU determines the discrepancies between individual poses exceed the defined threshold, it may still generate a master pose for the human operator. In such a configuration, the CPU 125 may generate a signal 130, and transmit it to a safety controller (e.g., 505 of FIG. 5), indicating there are potential errors or anomalies in generating individual poses, and therefore, the resulting master pose is considered invalid. The safety controller, upon receiving the error signal or accumulating a certain number of the error signals, may trigger an e-stop signal to halt or slow down the machine that the human operator is working with.

In some aspects, depending on the size and/or duration of the discrepancy detected, as well as the number of cameras 110 involved in the discrepancy, the e-stop signal may be automatically cleared once the error or discrepancy is resolved. In some aspects, particularly when the discrepancy is severe or involve critical operational risks, the e-stop signal may require manual clearance. A qualified system operator may inspect the equipment (e.g., cameras 110, processing unit 115, and CPU 125) and evaluate the data captured to address any underlying issues. After the manual intervention, the operator may reset the machine to continue the operations.

The process of merging or combining individual poses 120 into a master pose 135 may involve various techniques that ensure both accuracy and reliability of the resulting data. In some aspects, the CPU 125 may simply average the coordinates (x, y, z) of corresponding points across multiple poses. By calculating the mean value of each coordinate (x, y, z), random errors or biases within the data from any signal source can be effectively reduced. In some aspects, weighted averaging may be used, where the contributions of individual cameras may be weighted based on their reliability. For example, when a camera has a clearer view compared to others, its data may be given more weight in the final average. The weighted average allows higher quality data to have a greater impact on the final result and therefore improves the overall accuracy of the master pose 135. In some aspects, statistical methods may be used that incorporate predictive models to adjust the averaged coordinates based on observed trends. This approach may provide more accurate and responsive pose estimations in dynamic environments. In some aspects, outliers or anomaly detection algorithms may be applied to process the data to remove outlier data points. The outliers or anomaly detection algorithms may include, but are not limited to, the Z-score, percentile method, Tukey’s range, or Grubb’s test. By removing outliers, the process of generating the master pose 135 may focus on the most reliable and representative data, which improves the overall accuracy and reliability of the master pose 135.

The example workflow 100A depicts the built-in processing unit 115 generating individual poses 120 and the CPU 125 performing the cross-verification and generating the master pose 135. The illustrated example workflow is provided for conceptual clarity. In some aspects, all pose estimation tasks, from the initial analysis to final master pose generation, may be performed by a single CPU 125. In such configurations, each camera 110 provides its captured visual data directly to the CPU 125 for further analysis. The CPU 125 may then process the data to generate preliminary poses 120, perform cross-verification to check for discrepancies, and aggregate the validated poses into a master pose 135.

The example workflow 100A depicts three individual cameras 110 that are used to capture various angles of the human operator 105. The illustrated example workflow is provided for conceptual clarity. In some aspects, any number of cameras 110 (including one) may be used, depending on the specific requirements of the assigned task and the environment.

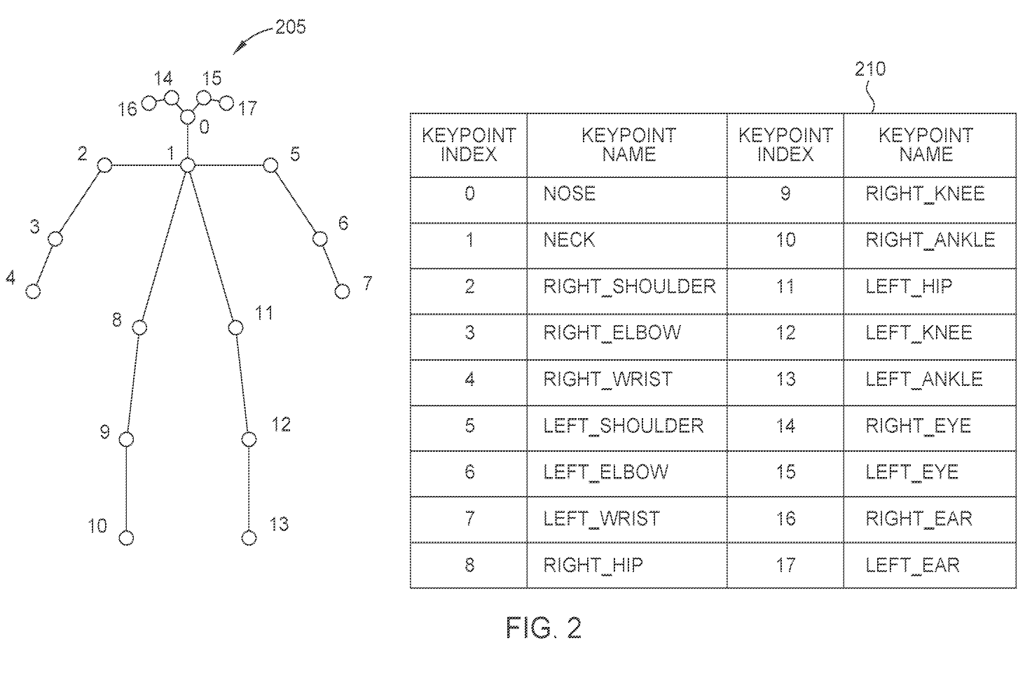

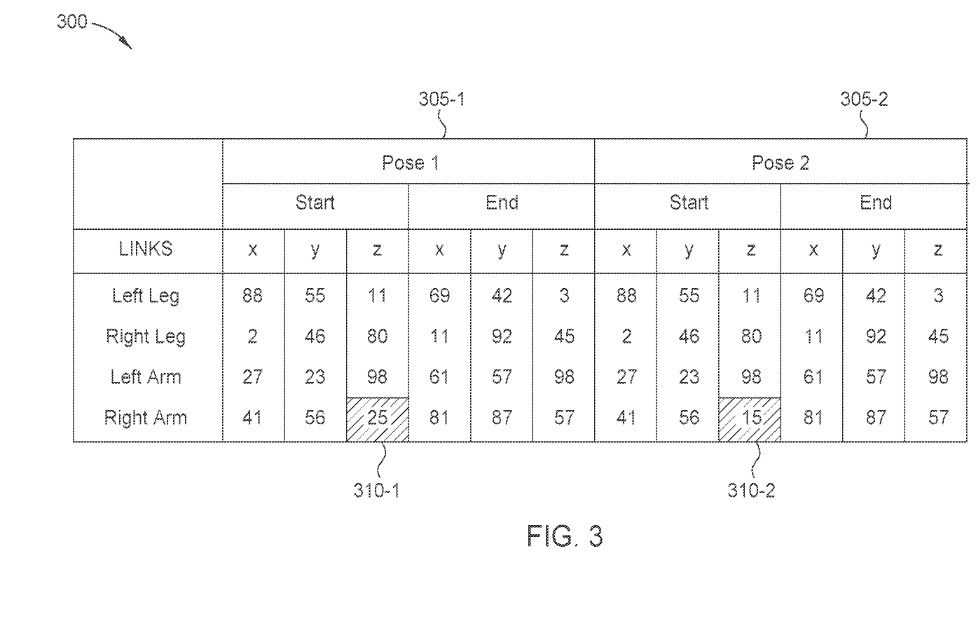

FIG. 2 depicts an example link frame pose 205 and an example index table 210 of human body parts for pose estimation, according to some aspects of the present disclosure. The example link frame pose 205 represents a human body in a 3D space. Each point in the link frame 205 is assigned to represent a specific human body part, and has 3D coordinates (x, y, z) indicating its position (as depicted in FIG. 3). For example, as illustrated in the example index table 210, point 0 represents the nose, point 1 represents the neck, and points 14 and 15 represent the left and right eyes, respectively.

The points are connected with lines to form a skeletal structure that maps out the human body in 3D space. The link frames (or lines) visually show how each point contributes to forming the overall pose of the human body. In some aspects, the example link frame (or skeleton) pose 205 may be generated by processing visual data captured by a signal camera (e.g., 110 of FIG. 1A).

FIG. 3 depicts an example coordinate table 300 of human body parts across multiple preliminary poses, according to some aspects of the present disclosure. The table 300 shows coordinate data for two poses, marked as Pose 1 (305-1) and Pose 2 (305-2). Each pose shows the positions of four limbs. As shown in FIG. 2, limbs may be depicted as linkages between two indexed points in a skeleton pose. For example, the linkage representing the left leg connects from point 8 (representing the right hip) to point 10 (representing the left ankle). The coordinates for the starting point of this linkage (e.g., point 8) are (88, 55, 11), and the coordinates for the endpoint (e.g., point 10) are (69, 42, 3).

In aspects where Pose 1 and Pose 2 are generated by two different cameras, the coordinates of points within each pose may be based on the frame of reference of each respective camera. To enable comparison, the coordinate data, originally based on the frame of reference of each respective local camera, may first be transformed into a global frame of reference. The table 300 shown here displays the coordinate data of Pose 1 and Pose 2 that has been transformed into the global frame, and therefore can be directly used for comparison.

As illustrated, the coordinates for the left leg, right leg, and left arm are consistent across both Pose 1 (305-1) and Pose 2 (305-2). However, a discrepancy occurs with the right arm, where the starting point in Pose 1 (305-1) has the coordinates (41, 56, 25), while in Pose 2 (305-2), the starting point shifts to (41, 56, 15). Specifically, the discrepancy in the Z coordinate between the two poses is 10, calculated by subtracting the Z coordinate (310-2) of Pose 2, which is 15, from the Z coordinate of Pose 1, which is 25 (310-1). The discrepancy may indicate potential bias or errors in the data capture or processing operations. The discrepancy may then be compared with a defined threshold to determine whether the variation is within an acceptable range.

In some aspects, the threshold may be determined by considering factors such as the precision required for the collaborative tasks, the typical range of motion observed in similar activities, and the sensitivity of the equipment (cameras or sensors) used to capture the data. In some aspects, the environmental conditions during the data capture may also be considered, such as lighting, obstructions, or other factors that may affect the accuracy of the cameras or sensors. If the discrepancy exceeds the threshold, an error alert (e.g., 140 of FIG. 1B) may be triggered to facilitate a review or corrective measures (e.g., recalibrating the sensors) to ensure data accuracy. If the discrepancy is within the threshold, it may be considered as a normal variation inherent to human motions or slight shifts in the subject’s positioning.

FIGS. 4A and 4B depicts an example workflow for enhanced pose estimation for a robot arm 405 using multi-angle image capture, according to some aspects of the present disclosure. In some aspects, the workflow 400A of FIG. 4A and workflow 400B of FIG. 4B (collectively, forming a workflow 400) may be performed by one or more computing devices, such as the built-in processing unit 115 or the CPU 125 as illustrated in FIGS. 1A and 1B, the built-in processing unit 415 or the CPU 425 as illustrated in FIGS. 4A and 4B, and/or the computing device 800 as illustrated in FIG. 8.

In the illustrated workflow 400A, the robot arm’s 405 movements are captured by three cameras 410-1, 410-2, and 410-3 from different angles within the operating area. Each camera 410 may be mounted in any position that provides a view of the operating area. As illustrated, each camera 410 has a built-in processing unit 415, which processes the visual data to generate a respective link frame (or skeleton) pose 420 of the robot arm 405. The link frame (or skeleton) pose 420 generated by each camera 410 provides a unique perspective of the robot arm’s 405 positions and/or movements within the operating area. In some aspects, points used within the link frame (or skeleton) pose 420 may represent joints of the robot arm 405, and lines connecting these points represent the mechanical linkages between these joints. The link frame pose 420 may be used to determine the positions, configurations, and/or movements of the robot arm at any given time.

As illustrated, the three individual poses (also referred to in some aspects as preliminary poses) 420 are provided to a CPU 425 to determine discrepancies among them. In some aspects, the CPU 425 may compare any two individual poses (e.g., 420-1 and 420-2) to detect a discrepancy. As discussed above with reference to FIG. 3, the discrepancies may be indicated by differences in the coordinates (x, y, z). When a discrepancy is detected, the CPU 425 may compare it with a defined threshold to determine whether the variation exceeds an acceptable limit. If the discrepancy exceeds the threshold, it may indicate a potential error or anomaly in the data. In such configurations, the CPU 425 proceeds to generate an error signal 440. In some aspects, the error signal 440 may prompt immediate action to stop or slow down the robot arm 405.

If the discrepancy is equal to or below the threshold, the CPU 425 may aggregate these poses into a master pose 435, and transmit a signal 430 to a safety controller (e.g., 505 of FIG. 5). In this configuration, the signal 430 may indicate the variation is acceptable and the resulting master pose 135 is valid. As discussed above, the aggregation process may involve simply average the coordinates (x, y, z) of corresponding points from each pose. In some aspects, more advanced techniques may be used, such as weighted averaging, which assigns different weights to data based on source reliability, or statistical methods that integrate prediction models for dynamic adjustment. In some aspects, following the generation of the master pose 435, the CPU 425 may generate a signal 430 to indicate that the master pose is valid and reliable for further actions, such as guiding the robot arm’s 405 movements in completing collaborative tasks with human operators.

In some aspects, the CPU 425 may generate a master pose 435 for the robot arm even if it has determined that the discrepancies between individual poses exceed the defined threshold. In this configuration, the CPU 425 may generate a signal 430, and provide it to a safety controller (e.g., 505 of FIG. 5), indicating that there are potential errors or anomalies in the generation of individual poses, and therefore, the resulting master pose is considered invalid.

The example workflow 400A depicts three individual cameras 410 that are used to capture various angles of the robot arm 405. The illustrated example workflow is provided for conceptual clarity. In some aspects, any number of cameras 410 (including one) may be used, depending on the specific requirements of the assigned task and the environment.

In some aspects, the cameras 410 may correspond to the cameras 110 as depicted in FIG. 1A, and the built-in processing units 415 may correspond to the built-in processing units 115 as depicted in FIG. 1A. In this configuration, the same cameras may be used to capture both the human operator 105 and the robot arm 405 within the operating area. The visual data may then be processed by the built-in processing units to generate preliminary poses 120 and 420 for the human operation and the robot arm, respectively. In some aspects, the CPU 425 may correspond to the CPU 125 as depicted in FIG. 1A. In this configuration, the same central processing infrastructure may be utilized to cross-check discrepancies within preliminary poses 120 and 420 for the human operator and the robot arm and, based on the check results, proceed with subsequent actions (e.g., generating an error signal, aggregating data to generate a master pose, or generating a signal indicating the master pose is valid).

FIG. 5 depicts an example workflow 500 for generating control signals based on the validity of both an operator master pose and a robot master pose, according to some aspects of the present disclosure.

In the illustrated workflow 500, individual preliminary poses 120 and 420 for the human operator 105 and the robot arm 405 are provided to the CPU 125 (which may correspond to the CPU 425 as depicted in FIG. 4A). The CPU 125 performs cross-verification to determine the existence of discrepancies and whether they are within an acceptable limit. Upon confirming that the discrepancies between any two of the preliminary poses 120 for the human operator 105 are within the threshold, the CPU 125 generates a master pose 135 for the human operator, and issues a signal 130 indicating the master pose is valid. Similarly, upon confirming that the discrepancies between any two of the preliminary poses 320 for the robot arm 405 are within the threshold, the CPU 125 generates a master pose 325 for the robot arm 405, and issues a corresponding signal 430. The signals 130 and 430 for both the human operator and the robot arm are then provided to the safety controller 505 and, in parallel, the master poses are forwarded to the dynamic motion planner 510. As illustrated, the dynamic motion planner 510 is connected to the safety controller 505. When receiving the both signals 130 and 430, indicating that the master poses are accurate and reliable, the safety controller 505 may instruct the dynamic motion planner 510 to proceed with the received master poses 135 and 435.This may include sending control signals 515 to the robot arm 405 to execute predefined tasks or adapting its movements to complement the human operator’s actions in real time. In some aspects, the human pose and/or the robot pose can be used by a safety control system to monitor and prevent hazards from occurring by monitoring speed and separation of different parts of the human and robot. Compared to traditional methods that typically use separate zones for safety monitoring, the pose estimation method allows for monitoring hazards at a more granular level, and therefore enables a more responsive and accurate approach for safety management.

If it is determined that the discrepancies between any two of the preliminary poses (either for the human operator or the robot arm) are above the threshold, an error signal (e.g., 440 or 140) is sent to the safety controller. In this configuration, the error signal may prompt the safety controller to send an e-stop signal 520 to immediately stop or slow down the robot arm 405. The response mechanism is configured to prevent accidents and ensure the safety of all personnel in the vicinity. In some aspects, to avoid overly conservative safety controls that may result in frequent slowdowns or stops based on a single anomaly (e.g., an invalid master pose), the safety controller 505 may be configured to tolerate a certain number of errors (within a defined period of time) before triggering a slowdown or e-stop. Depending on the reliability of an individual pose estimating sensor measured by a quantifiable figure such as mean time to dangerous failure (MTTFd) a number of sensors can be selected and an algorithm designed such that a MTTFd for the entire system can calculated. This MTTFd value can then be used to classify the system performance levels as per ISO 13849. As used herein, the error may refer to the receipt of an error signal (e.g., 140 of FIG. 1B, or 440 of FIG. 4B), which is generated when discrepancies between individual poses exceed defined thresholds. These discrepancies may be caused by various factors, such as minor deviations in the robot arm’s movements that do not actually pose a safety threat, or by transient sensor errors that quickly resolve themselves. Such discrepancies may lead to the generation of error signals 140 or 440 if they fall outside the acceptable limit set for safe operation, despite the fact that they do not represent real dangers. By setting the threshold for tolerance, the system may ensure that it responds proportionally to actual risks, allowing for minor errors without compromising the safety and efficiency of operations.

In some aspects, even with the determination that discrepancies exceed the threshold, the CPU 125 may nevertheless generate a master pose (for either the human operator or the robot arm). Along with this, a signal 130 or 430 is send to the safety controller 505, indicating the resulting master pose is considered invalid due to potential errors or anomalies in the generation of individual poses. The safety controller 505, configured with a mechanism to tolerate a defined number of errors, may continue to use the master pose for planning the robot arm’s path around the operator.

The illustrated workflow 500 shows the safety controller 505 receiving signals (indicating either errors or validation) for both human and robot poses. The illustrated workflow 500 is provided for conceptual clarity. In some aspects, the safety controller may only receive signals for the human poses 120. In such configurations, if the safety controller receives a signal 130 confirming that the master pose for the human is valid, it may allow the dynamic motion planner 510 to continue operations. If an error signal 140 is received, indicating potential errors in the pose estimation of the human operator, the safety controller 505 may promptly generate an e-stop signal to halt or slow down the robot arm 405.

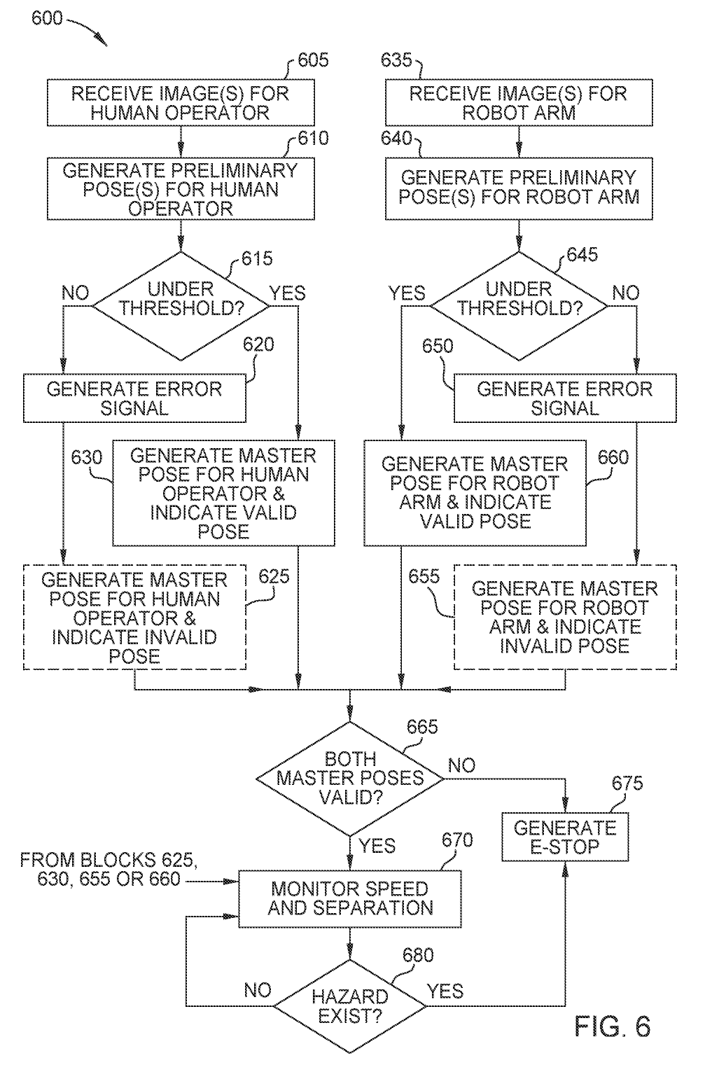

FIG. 6 depicts an example method 600 for generating master poses and controlling robot operations based on the validity of the master poses, according to some aspects of the present disclosure. In some aspects, the method 600 may be performed by one or more computing devices, such as the built-in processing units 115 or the CPU 125 as depicted in FIG. 1A, or the built-in processing units 415 or the CPU 425 as depicted in FIG. 4A, and/or the computing device 800 as depicted in FIG. 8.

At block 605, a computing device (e.g., 125 of FIG. 1A) receives images of a human operator (e.g., 105 of FIG. 1A). In some aspects, these images may be captured by multiple cameras (e.g., 110 of FIG. 1A) positioned around the operating area. Each camera may be located to optimize the field of view and minimize blind spots. All the images, put together, may provide a comprehensive coverage of the human operator from various angles.

At block 610, the computing device processes each image individually to generate a corresponding preliminary pose (e.g., 120-1, 120-2, or 120-3 of FIG. 1A) of the human operator. In some aspects, the device may utilize computing vision algorithms to detect points on the human body within the images. These points may include joints such as the wrists, shoulders, knees, wrists, and elbows, which help to define human posture. Using the detected points, the device may then generate a link frame (or skeleton) model of the human operator by connecting points into lines. The link frame model maps out the spatial relationships between joints, and effectively represents the human operator’s movements and positions in a 3D space. The link frame model generated from each image may correspond to a preliminary pose (e.g., 120 of FIG. 1A).

In some aspects, each camera (e.g., 110 of FIG. 1A) may operate with its own local frame of reference, and therefore generate preliminary poses (e.g., 120 of FIG. 1A) based on its own local frame of reference. To effectively compare these individual preliminary poses and detect discrepancies, the coordinates of each preliminary pose may be first converted from the local camera frame into a predefined global frame of reference. As used herein, the global frame may be established when setting up the safety-monitoring system, and is configured to standardize and integrate data across different camera views. After the conversion, the preliminary pose may then be cross-verified to detect discrepancies and generate a master pose.

In some aspects, the operations depicted by blocks 605 and 610 may be performed by cameras with built-in processing units (e.g., 115 of FIG. 1A). In this configuration, each built-in processing unit may use pose estimation algorithms to analyze the image data locally and generate corresponding preliminary poses.

At block 615, the computing device compares any two of the preliminary poses to determine discrepancies. If any discrepancies exceed a defined threshold, the method 600 proceeds to block 620, where the computing device generates an error signal (e.g., 140 of FIG. 1B) to stop or slow down the robot arm. In some aspects, as depicted by dashed block 625, upon determining that discrepancies exceed the defined threshold, the computing device may still generate a master pose (e.g., 135 of FIG. 1B) by aggregating individual preliminary poses, along with a signal (e.g., 130 of FIG. 1B) indicating the master pose is invalid due to potential errors or anomalies in generating individual poses. If all the detected discrepancies are equal to or fall below the defined threshold, the method 600 proceeds to block 630, where the computing device generates a master pose (e.g., 135 of FIG. 1B) for the human operator and a signal indicating that the master pose is valid. In some aspects, the aggregation process may involve aligning all the preliminary poses spatially to ensure they fit together in a cohesive structure that accurately represents the human operator’s posture.

At block 635, the computing device receives images of a robot arm (e.g., 405 of FIG. 4A) within the operating area. The robot arm may be engaging in collaborative tasks with the human operator (e.g., 105 of FIG. 1A). In some aspects, the subject captured may not be limited to a robot arm, and may include any machines that interacts with the human operator. In some aspects, these images may be captured by multiple cameras (e.g., 410 of FIG. 1A) from multiple angles to ensure a comprehensive coverage of the robot arm.

At block 640, the computing device processes the images to generate preliminary poses (e.g., 420 of FIG. 4A) for the robot arm. In some aspects, each image may be processed independently to generate a corresponding preliminary pose. The pose may include a link frame (or skeleton) structure where points represent joints of the robot arm, and lines represent mechanical linkages connecting these joints. Each pose may provide an individual representation of the robot arm’s posture captured by a specific camera (e.g., 410 of FIG. 4A) and is built on the local frame of reference of that camera. For effective comparison and integration of these individual poses, the coordinates from each camera’s local frame of reference may be converted into a global frame of reference.

In some aspects, the operations as depicted by blocks 635 and 640 may be performed by cameras with built-in processing units (e.g., 415 of FIG. 4A), which are capable of processing the images locally and generating corresponding preliminary poses.

At block 645, the computing device compares the preliminary poses to detect discrepancies. If any discrepancies exceed a defined threshold, the method 600 proceeds to block 650, where the device generates an error signal (e.g., 440 of FIG. 4B) to stop or slow down the robot arm. In some aspects, as depicted in dashed block 655, the computing device, upon determining that discrepancies exceed the defined threshold, may still generate a master pose (e.g., 435 of FIG. 1B) of the robot arm, along with a signal (e.g., 430 of FIG. 1B) indicating the master pose is invalid due to potential errors or anomalies in generating individual poses. The master pose may then be provided for further hazard monitoring. If the discrepancies are within the threshold, the method 600 proceeds to block 660, where the device aggregates the preliminary poses (e.g., 420 of FIG. 4B) into a master pose (e.g., 435 of FIG. 4B) for the robot arm, and generates a signal indicating the resulting master pose is valid.

In some aspects, the operations of generating a master pose for the human operator (as depicted by blocks 605-630) and the operations of generating a master pose for the robot arm (as depicted by blocks 635-660) may be performed in parallel or in series by the computing device. In parallel processing, the computing device may handle the data stream simultaneously, which allows for quicker integration and responses. In series processing, each master pose may be generated one after the other. Such a mechanism may be used when the computing device has limited resources and simultaneous data processing is not feasible.

In some aspects, the threshold used (at block 615) to measure discrepancies in individual poses for the human operator are the same as the threshold used (at block 640) to measure discrepancies in individual poses for the robot arm. In some aspects, these two thresholds may be different, considering the characteristics and requirements of each entity. For example, human movements are generally more flexible and complex compared to those of robot arms. Therefore, the threshold for discrepancies in human poses may be more lenient to accommodate the natural human variability without compromising safety. In contrast, robot arms, especially those used in industrial settings, are often designed to perform precise and repetitive tasks. Therefore, the threshold for discrepancies in robot poses may be set stricter to ensure that every movement is accurate to maintain the quality and precision of operations.

At block 665, the computing device determines whether both master poses (one for the human operator and the other for the robot arm) are valid. As discussed above, a master pose is considered valid when the discrepancies between individual preliminary poses are within the predefined threshold. The signal (e.g., 130 of FIG. 1B or 430 of FIG. 4B) indicates that the aggregated data reliably represent the actual movements and positions of the captured subject (e.g., the human operator or the robot arm). The master pose is considered invalid if discrepancies exceed the threshold, suggesting potential inaccuracies or errors in the data capture or pose estimation operations that may compromise safety and operational integrity. If both master poses are valid, the method 600 proceeds to block 670, where the computing device uses these poses to monitor the human operator’s posture and their interactions with the robot arm to detect any hazards. If either master pose is invalid the method 600 proceeds to block 675, where the computing device generates an e-stop signal (e.g., 520 of FIG. 5) to stop or slow down the robot arm, preventing any possible accidents or unsafe interactions. In this configuration, the invalid master poses continue to be provided for hazard monitoring.

At block 670, the computing device uses the master poses to interpret the human operator’s posture and their interactions with the robot arm. In some aspects, these assessments may also be used to dynamically design the robot arm’s path and actions around the operator, which optimize both safety and efficiency of the collaborative workspaces. At block 680, the computing device analyzes the interactions to determine whether any hazard exists, such as the human operator’s hand being too close to the robot arm’s operational parts, any overlaps in the movement paths that could lead to collisions, or situations where the operator is within the robot arm’s high-speed movement area. If any hazard is detected, an e-stop signal is immediately triggered to stop or slow down the robot arm (as depicted by block 675). If no immediate hazard is detected, the method 600 returns to block 670, where the computing device continue to monitor the environment and/or operator’s posture to dynamically assess risks. In some aspects, to avoid overly conservative safety controls that result in frequency slowdowns or stops based on a signal anomaly (e.g., an error signal), the computing device may set up a threshold for triggering the safety control signal (also referred to in some aspects as e-stop signal). In some aspects, the threshold may be defined as the number of errors detected within a defined period of time. As used herein, the error may refer to the receipt of an error signal for a master pose (e.g., 140 of FIG. 1B, 440 of FIG. 4B), indicating discrepancies that exceed the acceptable limit. For example, if a master pose is generated every second (with camera capturing images at the same interval), the threshold for safety control may be set at 5 errors within 30 seconds. If the computing device receives 5 error signals (whether for the operator master pose or the robot master pose), within 30 seconds, it then triggers the safety control signal to stop or slow down the machine. By implementing the safety control threshold, the computing device may maintain a high safety standard while allowing for a buffer against minor or transient errors.

In some aspects, the computing device may only verify the validity of the master pose for human operator (e.g., 135 of FIG. 5) and skip the operation of creating a master pose for the robot arm (as depicted by blocks 635-660). This may occur when the pose of the robot arm is already available from the robot control system and can be used directly instead of having to estimate its mater pose. In this configuration, if the master pose for the human operator is confirmed as valid, the computing device may continue to use the human operator’s poses along with the robot arm’s pose (provided by the robot control system to monitor hazards and facilitate safe and efficient interactions. If an error signal (e.g., 140 of FIG. 1B) is received indicating potential errors in the human operator’s pose estimation or the master pose for the human operator is indicated as invalid (e.g., 130 of FIG. 1B), the computing device may trigger an e-stop to stop or slow down the robot arm’s operations.

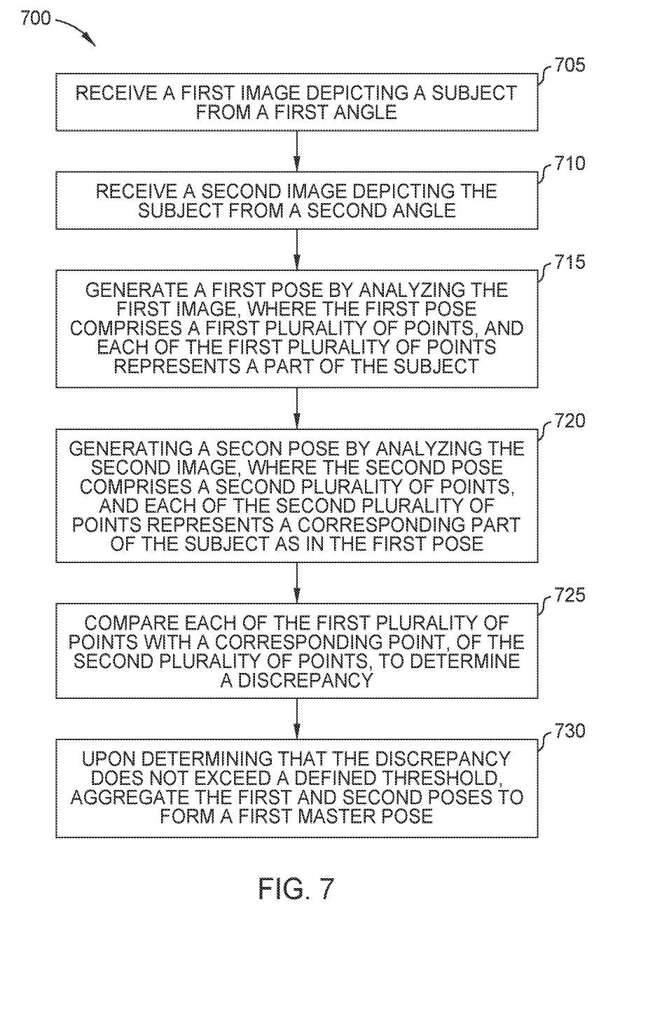

FIG. 7 is a flow diagram depicting an example method 700 for master pose estimation, according to some aspects of the present disclosure.

At block 705, a computing device (e.g., the built-in processing unit 115 or the CPU 125 of FIG. 1A) receives a first image depicting a subject (e.g., the human operator 105 of FIG. 1A) from a first angle.

At block 710, the computing device receives a second image depicting the subject from a second angle.

At block 715, the computing device generates a first pose (e.g., 120-1 of FIG. 1A) by analyzing the first image, where the first pose comprises a first plurality of points, and each of the first plurality of points represents a part of the subject.

At block 720, the computing device generates a second pose (e.g., 120-2 of FIG. 1A) by analyzing the second image, where the second pose comprises a second plurality of points, and each of the second plurality of points represents a corresponding part of the subject as in the first pose.

At block 725, the computing device compares each of the first plurality of points with a corresponding point, of the second plurality of points, to determine a discrepancy.

At block 730, upon determining that the discrepancy does not exceed a defined threshold, the computing device aggregates the first and second poses to form a first master pose (e.g., 135 of FIG. 1B).

In some aspects, the computing device may further compare each of a third plurality of points with a corresponding point, of a fourth plurality of points, to determine a second discrepancy, and upon determining that the second discrepancy exceeds the predefined threshold, generate an error signal (e.g., 140 of FIG. 1B) that indicates an error in pose estimation.

In some aspects, when aggregating the first and second poses to form the first master pose (e.g., 135 of FIG. 1A), the computing device may generate an average between coordinates of a point from the first pose (e.g., 120-1 of FIG. 1A) and coordinates of a corresponding point from the second pose (e.g., 120-2 of FIG. 1A).

In some aspects, the computing device may generate a control signal (e.g., 130 of FIG. 1B) that indicates that the first master pose is valid.

In some aspects, the computing device may receive a third image depicting a second subject (e.g., the robot arm 405 of FIG. 4A) from a third angle, receive a fourth image depicting the second subject from a fourth angle, generate a third pose (e.g., 420-1 of FIG. 4A) by analyzing the third image, where the third pose comprises a third plurality of points, and each of the third plurality of points represents a part of the second subject, generate a fourth pose (e.g., 420-2 of FIG. 4A) by analyzing the fourth image, where the fourth pose comprises a fourth plurality of points, and each of the fourth plurality of points represents a corresponding part of the second subject as in the third pose, compare each of the third plurality of points with a corresponding point, of the fourth plurality of points, to determine a second discrepancy, and upon determining that the second discrepancy does not exceed a second defined threshold, aggregate the third and fourth poses to form a second master pose (e.g., 435 of FIG. 4B).

In some aspects, upon determining that the first and second master poses are valid, the computing device may control actions of the second subject (e.g., the robot arm 405 of FIG. 5) based on the first and second poses.

In some aspects, upon determining that either of the first and second master poses is invalid, the computing device may generate a stop signal (e.g., 520 of FIG. 5) that instructs the second subject to slow down or stop entirely.

FIG. 8 depicts an example computing device 800 supporting pose-based machine control and management, according to some aspects of the present disclosure. Although depicted as a physical device, in some aspects, the computing device 800 may be implemented using virtual device(s), and/or across a number of devices (e.g., in a cloud environment). In some aspects, the computing device 800 may correspond to the built-in processing units 115 or the CPU 125 as depicted in FIG. 1A, or the built-in processing units 415 or the CPU 425 as depicted in FIG. 4A.

As illustrated, the computing device 800 includes a CPU 805, memory 810, storage 815, one or more network interfaces 825, and one or more I/O interfaces 820. In the illustrated aspect, the CPU 805 retrieves and executes programming instructions stored in memory 810, as well as stores and retrieves application data residing in storage 815. The CPU 805 is generally representative of a single CPU and/or GPU, multiple CPUs and/or GPUs, a single CPU and/or GPU having multiple processing cores, and the like. The memory 810 is generally considered to be representative of a random access memory. Storage 815 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some aspects, I/O devices 835 (such as keyboards, monitors, etc.) are connected via the I/O interface(s) 820. Further, via the network interface 825, the computing device 800 can be communicatively coupled with one or more other devices and components (e.g., via a network, which may include the Internet, local network(s), and the like). As illustrated, the CPU 805, memory 810, storage 815, network interface(s) 825, and I/O interface(s) 820 are communicatively coupled by one or more buses 830.

In the illustrated aspect, the memory 810 includes an image processing component 850, a pose estimation component 855, a dynamic motion planning component 860, and a safety control component 865. Although depicted as discrete components for conceptual clarity, in some aspects, the operations of the depicted components (and others not illustrated) may be combined or distributed across any number of components. Further, although depicted as software residing in memory 810, in some aspects, the operations of the depicted components (and others not illustrated) may be implemented using hardware, software, or a combination of hardware and software.

In the illustrated example, the image processing component 850 may be used to process images captured by cameras (e.g., 110 of FIG. 1A or 410 of FIG. 4A). The image processing component 850 may process the images to enhance their clarity, apply filters or correction to improve the quality of the visual data, or perform initial data extraction. The processed visual data may then be provided to the pose estimation component 855 for further analysis.

In the illustrated example, the pose estimation component 855 may generate individual poses (also referred to in some aspects as preliminary poses) based on the processed visual data. Each individual pose (e.g., 120 of FIG. 1A or 420 of FIG. 4A) may map the position and movements of the subject (the human operator or robot arm) in the operating environment.

In the illustrated example, the discrepancy control component 860 may compare any two of the individual poses to determine whether discrepancies are within an acceptable limit. If all discrepancies are equal to or fall below the limit (or threshold), the component 860 may instruct the pose estimation component 855 to aggregate the individual poses to generate a master pose for the subject (the human operator or robot arm) (e.g., 135 of FIG. 1B or 435 of FIG. 4B). If any discrepancy exceeds the limit (or threshold), the component 860 may generate an error signal (e.g., 140 of FIG. 1B or 440 of FIG. 4B), indicating there are potential errors or anomalies in pose capture or estimation. In some aspects, the error signal may be provided to the system operator or the safety management team to prompt immediate review or intervention to address the discrepancies. In some aspects, the error signal may be provided to the safety control component 870, indicating the resulting master pose is invalid.

In the illustrated example, the dynamic motion planning component 865 may receive the master poses (e.g., 135 of FIG. 1B and 435 of FIG. 4B) for the human operator and the machine from the pose estimation component 855. Based on the received master poses, the dynamic motion planning component 860 may develop and/or adjust robotic movements to ensure coordinated interactions with the human operator. In some aspects, the dynamic motion adjustment may optimize safety and productivity.

In the illustrated example, the safety control component 870 may monitor the system for any signals that indicate the master poses for the human operator and machine (e.g., robot arm) are valid, as well as signals that indicate discrepancies and/or pose estimation failure. Upon receiving signals confirming that both master poses are valid, the component 870 may instruct the dynamic motion planning component 865 to proceed with facilitating coordinated interactions between the human operator and the machine. If the safety control component 870 receives an error signal, or accumulate a certain number of error signals (within a defined period of time) indicating a master pose is invalid, the component 870 may generate an e-stop signal to immediately halt or slowdown the machine’s operations. The e-stop signal may ensure the human operator’s safety and prevent potential accidents or malfunctions in the system.

In the illustrated example, the storage 815 may include a variety of data for effective operation and management of the safety-rated system, including, but not limited to, images 875 captured from cameras positioned around the operating area, preliminary poses 880 generated directly from the analysis of the captured images, master poses 885 aggregated from multiple preliminary poses, signal records 890 (including all safety-related signals, like error signals, validity signals, or e-stop signals), and dynamic motion plans 895 (including detailed commands and sequences instructed to robotic components based on the master poses). In some aspects, the aforementioned data may be saved in a remote database that connects to the computing device 800 via a network (e.g., the Internet).

In the current disclosure, reference is made to various aspects. However, it should be understood that the present disclosure is not limited to specific described aspects. Instead, any combination of the following features and elements, whether related to different aspects or not, is contemplated to implement and practice the teachings provided herein. Additionally, when elements of the aspects are described in the form of “at least one of A and B,” it will be understood that aspects including element A exclusively, including element B exclusively, and including element A and B are each contemplated. Furthermore, although some aspects may achieve advantages over other possible solutions and/or over the prior art, whether or not a particular advantage is achieved by a given aspect is not limiting of the present disclosure. Thus, the aspects, features, aspects and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects described herein may be embodied as a system, method or computer program product. Accordingly, aspects may take the form of an entirely hardware aspect, an entirely software aspect (including firmware, resident software, micro-code, etc.) or an aspect combining software and hardware aspects that may all generally be referred to herein as a “circuit,” “module” or “system.” Furthermore, aspects described herein may take the form of a computer program product embodied in one or more computer readable storage medium(s) having computer readable program code embodied thereon.

Program code embodied on a computer readable storage medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to aspects of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various aspects of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

While the foregoing is directed to aspects of the present disclosure, other and further aspects of the disclosure may be devised without departing from the basic scope thereof, and the scope thereof is determined by the claims that follow.

What is claimed is:

1. A method, comprising:
receiving a first image depicting a subject from a first angle;
receiving a second image depicting the subject from a second angle;
generating a first pose by analyzing the first image, wherein the first pose comprises a first plurality of points, and each of the first plurality of points represents a part of the subject;
generating a second pose by analyzing the second image, wherein the second pose comprises a second plurality of points, and each of the second plurality of points represents a corresponding part of the subject as in the first pose;
comparing each of the first plurality of points with a corresponding point, of the second plurality of points, to determine a discrepancy; and
upon determining that the discrepancy does not exceed a defined threshold, aggregating the first and second poses to form a first master pose.

2. The method of claim 1, further comprising:
comparing each of a third plurality of points with a corresponding point, of a fourth plurality of points, to determine a second discrepancy; and
upon determining that the second discrepancy exceeds the defined threshold, generating an error signal that indicates an error in pose estimation.

3. The method of claim 1, wherein aggregating the first and second poses to form the first master pose comprises generating an average between coordinates of a point from the first pose and coordinates of a corresponding point from the second pose.

4. The method of claim 1, further comprising generating a control signal that indicates that the first master pose is valid.

5. The method of claim 1, further comprising:
receiving a third image depicting a second subject from a third angle;
receiving a fourth image depicting the second subject from a fourth angle;
generating a third pose by analyzing the third image, wherein the third pose comprises a third plurality of points, and each of the third plurality of points represents a part of the second subject;
generating a fourth pose by analyzing the fourth image, wherein the fourth pose comprises a fourth plurality of points, and each of the fourth plurality of points represents a corresponding part of the second subject as in the third pose;
comparing each of the third plurality of points with a corresponding point, of the fourth plurality of points, to determine a second discrepancy; and
upon determining that the second discrepancy does not exceed a second defined threshold, aggregating the third and fourth poses to form a second master pose.

6. The method of claim 5, further comprising, upon determining that the first and second master poses are valid, controlling actions of the second subject based on the first and second poses.

7. The method of claim 5, further comprising, upon determining that either of the first and second master poses is invalid, generating a stop signal that instructs the second subject to slow down or stop entirely.

8. A system comprising:
one or more computer processors; and
one or more memories collectively containing one or more programs, which, when executed by the one or more computer processors, perform operations, the operations comprising:
receiving a first image depicting a subject from a first angle;
receiving a second image depicting the subject from a second angle;
generating a first pose by analyzing the first image, wherein the first pose comprises a first plurality of points, and each of the first plurality of points represents a part of the subject;
generating a second pose by analyzing the second image, wherein the second pose comprises a second plurality of points, and each of the second plurality of points represents a corresponding part of the subject as in the first pose;
comparing each of the first plurality of points with a corresponding point, of the second plurality of points, to determine a discrepancy; and
upon determining that the discrepancy does not exceed a defined threshold, aggregating the first and second poses to form a first master pose.

9. The system of claim 8, wherein the one or more programs, which, when executed on any combination of the one or more computer processors, perform the operations further comprising:
comparing each of a third plurality of points with a corresponding point, of a fourth plurality of points, to determine a second discrepancy; and
upon determining that the second discrepancy exceeds the defined threshold, generating an error signal that indicates an error in pose estimation.

10. The system of claim 8, wherein, to aggregate the first and second poses to form the first master pose, the one or more programs, which, when executed on any combination of the one or more computer processors, perform the operations comprising generating an average between coordinates of a point from the first pose and coordinates of a corresponding point from the second pose.

11. The system of claim 8, wherein the one or more programs, which, when executed on any combination of the one or more computer processors, perform the operations further comprising generating a control signal that indicates that the first master pose is valid.

12. The system of claim 8, wherein the one or more programs, which, when executed on any combination of the one or more computer processors, perform the operations further comprising:
receiving a third image depicting a second subject from a third angle;
receiving a fourth image depicting the second subject from a fourth angle;
generating a third pose by analyzing the third image, wherein the third pose comprises a third plurality of points, and each of the third plurality of points represents a part of the second subject;
generating a fourth pose by analyzing the fourth image, wherein the fourth pose comprises a fourth plurality of points, and each of the fourth plurality of points represents a corresponding part of the second subject as in the third pose;
comparing each of the third plurality of points with a corresponding point, of the fourth plurality of points, to determine a second discrepancy; and
upon determining that the second discrepancy does not exceed a second defined threshold, aggregating the third and fourth poses to form a second master pose.

13. The system of claim 12, wherein the one or more programs, which, when executed on any combination of the one or more computer processors, perform the operations further comprising, upon determining that the first and second master poses are valid, controlling actions of the second subject based on the first and second poses.

14. The system of claim 12, wherein the one or more programs, which, when executed on any combination of the one or more computer processors, perform the operations further comprising, upon determining that either of the first and second master poses is invalid, generating a stop signal that instructs the second subject to slow down or stop entirely.

15. One or more non-transitory computer-readable media containing, in any combination, computer program code that, when executed by operation of a computer system, performs operations comprising:
receiving a first image depicting a subject from a first angle;
receiving a second image depicting the subject from a second angle;
generating a first pose by analyzing the first image, wherein the first pose comprises a first plurality of points, and each of the first plurality of points represents a part of the subject;
generating a second pose by analyzing the second image, wherein the second pose comprises a second plurality of points, and each of the second plurality of points represents a corresponding part of the subject as in the first pose;
comparing each of the first plurality of points with a corresponding point, of the second plurality of points, to determine a discrepancy; and
upon determining that the discrepancy does not exceed a defined threshold, aggregating the first and second poses to form a first master pose.

16. The one or more non-transitory computer-readable media of claim 15, wherein the computer program code that, when executed by operation of the computer system, performs operations further comprising:
comparing each of a third plurality of points with a corresponding point, of a fourth plurality of points, to determine a second discrepancy; and
upon determining that the second discrepancy exceeds the defined threshold, generating an error signal that indicates an error in pose estimation.

17. The one or more non-transitory computer-readable media of claim 15, wherein the computer program code that, when executed by operation of the computer system, performs operations further comprising:
receiving a third image depicting a second subject from a third angle;
receiving a fourth image depicting the second subject from a fourth angle;
generating a third pose by analyzing the third image, wherein the third pose comprises a third plurality of points, and each of the third plurality of points represents a part of the second subject;
generating a fourth pose by analyzing the fourth image, wherein the fourth pose comprises a fourth plurality of points, and each of the fourth plurality of points represents a corresponding part of the second subject as in the third pose;
comparing each of the third plurality of points with a corresponding point, of the fourth plurality of points, to determine a second discrepancy; and
upon determining that the second discrepancy does not exceed a second defined threshold, aggregating the third and fourth poses to form a second master pose.

18. The one or more non-transitory computer-readable media of claim 15, wherein the computer program code that, when executed by operation of the computer system, performs the operations further comprising, upon determining that the first and second master poses are valid, controlling actions of the second subject based on the first and second poses.

19. The one or more non-transitory computer-readable media of claim 15, wherein, to aggregate the first and second poses to form the first master pose, the computer program code that, when executed by operation of the computer system, performs the operations comprising generating an average between coordinates of a point from the first pose and coordinates of a corresponding point from the second pose.

20. The one or more non-transitory computer-readable media of claim 15, wherein the computer program code that, when executed by operation of the computer system, performs the operations further comprising, upon determining that either of the first and second master poses is invalid, generating a stop signal that instructs the second subject to slow down or stop entirely.
